(19) United States
(12) Patent Application Publication
(10) Pub. No.: US 2021/0229883 A1
(43) Pub. Date: Jul. 29, 2021

(54) BIODEGRADABLE ADDITIVE

(71) Applicant: Jarod D. Wenrick, Tipp City, OH (US)

(72) Inventor: Jarod D. Wenrick, Tipp City, OH (US)

(21) Appl. No.: 17/160,476

(22) Filed: Jan. 28, 2021

Related U.S. Application Data
(60) Provisional application No. 62/967,360, filed on Jan. 29, 2020.

(51) Int. Cl. B65D 65/46; B65D 65/42; B65D 65/40; C09J 103/02; C09J 11/04

(52) U.S. Cl. CPC B65D 65/466; B65D 65/42; C09J 11/04; C09J 103/02; B65D 65/403

(57) ABSTRACT

A biodegradable additive is provided to enhance decomposition of a packaging material and/or to release nutrients into the soil as the packaging material decomposes. The biodegradable additive can be applied to a surface of the packaging material as a coating and/or as an adhesive to bond two or more layers of the packaging material together. The biodegradable additive includes an organic fertilizer having one or more nutrients such that the biodegradable additive can release the one or more nutrients when the packaging material decomposes.

### PRIORITY

This application claims priority to U.S. Provisional Application No. 62/967,360, entitled “Biodegradable Agriculture and Landscape Material,” filed on Jan. 29, 2020, the disclosure of which is incorporated by reference herein.

### TECHNICAL FIELD

The present disclosure is directed in general to the field of biodegradable additives for packaging materials and, more particularly, to a biodegradable additive having an organic fertilizer.

### BACKGROUND

Packaging materials (e.g., corrugated material, cardboard, paper, molded pulp, plastic, etc.) are typically used to store one or more goods during transport. This can include containers for packaging goods during shipment and/or carriers for food and/or drink. In some versions, packaging materials include a corrugated material having two or more layers that are bonded together by an adhesive. Such packaging materials can be discarded after use. Currently, these packaging materials can remain undecomposed for years and fail to provide a beneficial aspect when the packaging materials are decomposed into soil.

Accordingly, described herein is a biodegradable additive for packaging materials that is configured to enhance decomposition of the packaging materials and/or to release nutrients into the soil as the packaging materials decompose.

### BRIEF DESCRIPTION OF THE DRAWINGS

The accompanying drawings illustrate embodiments which serve to explain the principles of the present innovation.

FIG. 1 is a side elevational view of a corrugated material comprising an adhesive having an exemplary biodegradable additive.

FIG. 2 is a flowchart of a method of manufacturing the corrugated material of FIG. 1.

FIG. 3 is a side elevational view of a packaging material comprising a coating of the biodegradable additive of FIG. 1.

The drawings are not intended to be limiting in any way, and it is contemplated that various embodiments of the innovation may be carried out in a variety of other ways, including those not necessarily depicted in the drawings. The accompanying drawings incorporated in and forming a part of the specification illustrate several aspects of the present innovation, and together with the description serve to explain the principles of the innovation; it being understood, however, that this innovation is not limited to the precise arrangements shown.

### DETAILED DESCRIPTION

The following description of certain examples of the innovation should not be used to limit the scope of the present innovation. Other examples, features, aspects, embodiments, and advantages of the innovation will become apparent to those skilled in the art from the following description, which is by way of illustration, one of the best modes contemplated for carrying out the innovation. As will be realized, the innovation is capable of other different and obvious aspects, all without departing from the innovation. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

For clarity of disclosure, spatial terms such as “top,” “bottom,” and “interior,” are used herein for reference to relative positions and directions. Such terms are used below with reference to views as illustrated for clarity and are not intended to limit the innovation described herein.

The word “exemplary” is used herein to mean “serving as an example, instance, or illustration.” Any implementation described herein as “exemplary” is not necessarily to be construed as preferred or advantageous over other implementations.

A biodegradable additive is provided to enhance decomposition of a packaging material and/or to release nutrients into the soil as the packaging material decomposes. The packaging material can comprise a corrugated material having two or more layers such as a substantially flat layer and a fluted layer positioned adjacent to the substantially flat layer. In some versions, the fluted layer is positioned between a top layer and a bottom layer. The two or more layers are bonded together with an adhesive comprising a biodegradable additive. The biodegradable additive includes an organic fertilizer, such as seaweed extract (e.g., kelp), alfalfa meal, bat guano, fish emulsion, cotton seed, meal corn, gluten meal, cow manure, green sand, compost, soybean meal, blood meal, bone meal, feather meal, fish meal, etc. In some other versions, a coating comprising the biodegradable additive can be applied to a surface of the packaging material. Accordingly, the packaging material can act as a renewable source of organic biodegradable fertilizer that may help the packaging material decompose more easily and/or contribute to ground soil enrichment as the packaging material decomposes.

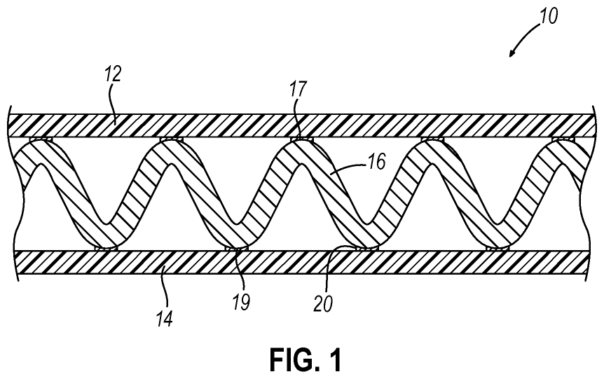

Referring to FIG. 1, a corrugated material 10 is shown comprising a substantially flat top layer 12, a substantially flat bottom layer 14, and a fluted layer 16 positioned between top layer 12 and bottom layer 14. Fluted layer 16 includes an undulating configuration such that fluted layer 16 forms a plurality of peaks 17 at a top portion of fluted layer 16 and a plurality of troughs 19 at a bottom portion of fluted layer 16. Accordingly, each peak 17 of fluted layer 16 is positioned against an interior surface of top layer 12 and each trough 19 of fluted layer 16 is positioned against an interior surface of bottom layer 14. Top, bottom, and fluted layers 12, 14, 16 of corrugated material 10 can include cardboard, paper, virgin cellulose paper, recycled cellulose paper, plastic, or any other suitable material. For instance, in some versions, corrugated material 10 is sufficiently rigid such that corrugated material 10 can be used for packaging one or more goods during shipment, as a plant carrier that can be planted directly into the soil, and/or as molded pulp packaging such as for food and/or drink carriers. In some other versions, corrugated material 10 is flexible such that corrugated material 10 can be used as a weed barrier in landscaping. Still other suitable configurations for corrugated material 10 will be apparent to one with ordinary skill in the art in view of the teachings herein. For instance, while corrugated material 10 is shown having three layers 12, 14, 16, corrugated material 10 can include any suitable number of two or more layers 12, 14, 16.

Corrugated material 10 further comprises an adhesive 20 applied between fluted layer 16 and top and bottom layers 12, 14 to bond fluted layer 16 with top and bottom layers 12, 14. In the illustrated version, each peak 17 of fluted layer 16 is bonded to the interior surface of top layer 12 by adhesive 20 and each trough 19 of fluted layer 16 is bonded to the interior surface of bottom layer 14 by additive 20. Adhesive 20 comprises a biodegradable additive such that adhesive 20 is configured to enhance organic decomposition of corrugated material 10 and/or to release nutrients (e.g., nitrogen, phosphorus and potassium, etc.) and/or amino acids into soil as it decomposes. For instance, the biodegradable additive can include an organic fertilizer in a soluble liquid and/or powder form. Such organic fertilizers can include a seaweed extract (e.g., kelp), alfalfa meal, bat guano, fish emulsion, cotton seed, meal corn, gluten meal, cow manure, green sand, compost, soybean meal, blood meal, bone meal, feather meal, fish meal, etc. An example of a seaweed extract is Kelp-It™ Soluble Powder made by North American Kelp in Waldoboro, Me.

Accordingly, adhesive 20 can comprise a mixture of one or more of water, starch, borax, caustic soda, and a biodegradable additive such as seaweed extract. For instance, adhesive 20 can comprise from about 70% to about 78% water. The starch of adhesive 20 can include corn, wheat, pea, tapioca, etc. Adhesive 20 can comprise from about 22% to about 29% starch. The caustic soda of adhesive 20 can include a sodium hydroxide 50% solution. Adhesive 20 can comprise from about 0.8% to about 1% caustic soda. Adhesive 20 can comprise from about 0.3% to about 0.6% borax. Adhesive 20 can comprise from about 3% to about 5% seaweed extract power. Still other suitable configurations for adhesive 20 will be apparent to one with ordinary skill in the art in view of the teachings herein for bonding layers 12, 14, 16 of corrugated material 10.

Corrugated material 10 can thereby act as a renewable source of organic biodegradable fertilizer to allow corrugated material 10 to decompose more easily than a corrugated material without a biodegradable additive and/or to contribute to ground soil enrichment as corrugated material 10 decomposes. This may enhance landfills receiving disposed products having corrugated material 10 and/or soil receiving landscaping products incorporating corrugated material 10. The use of a seaweed extract in adhesive 20 may further provide a use for excess seaweed that may be a nuisance.

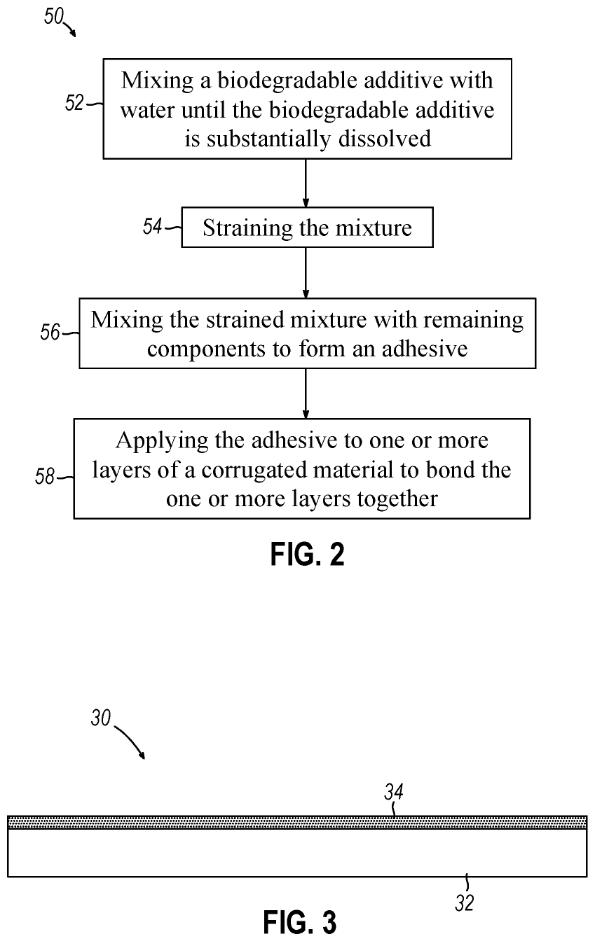

Referring to FIG. 2, an exemplary method 50 is shown for manufacturing corrugated material 10. Method 50 comprises a step 52 of mixing a biodegradable additive with water. The biodegradable additive can be in liquid and/or powder form. The biodegradable additive can be mixed with water until the biodegradable additive is substantially dissolved. For instance, the biodegradable additive can be mixed with water at a temperature from about 95° F. to about 100° F. for about 5 minutes to about 10 minutes. Method 50 further comprises a step 54 of straining the mixture. In some versions, a 190 micron filter can be used to strain the mixture. Method 50 further comprises a step 56 of mixing the strained mixture with the remaining components, such as starch, borax, caustic soda, etc, to form adhesive 20. Once mixed, adhesive 20 can be applied between layers 12, 14, 16 of corrugated material 10 to bond layers 12, 14, 16 of corrugated material (step 58). For instance, adhesive 20 can be sprayed and/or roll coated onto of one or more layers 12, 14, 16 of corrugated material 10. Still other suitable methods of manufacturing corrugated material 10 will be apparent to one with ordinary skill in the art in view of the teachings herein.

Additionally or alternatively, the biodegradable additive can be applied as a coating on a packaging material. Referring to FIG. 3, a packaging material 30 is shown comprising a packaging layer 32 that is sufficiently rigid such that packaging layer 32 can be configured as a container and/or carrier for transporting one or more goods. Packaging layer can comprise cardboard, paper, virgin cellulose paper, recycled cellulose paper, plastic, molded pulp, or any other suitable material configured for transporting goods. Coating 34 is applied to at least a portion of one or more surfaces of packaging layer 32. Coating 34 comprises a biodegradable additive as described above. For instance, coating 34 can comprise an organic fertilizer such as a seaweed extract. Coating 34 can be made by mixing the biodegradable additive with water. The biodegradable additive can be in liquid and/or powder form. The biodegradable additive can be mixed with water until the biodegradable additive is substantially dissolved. For instance, the biodegradable additive can be mixed with water at a temperature from about 95° F. to about 100° F. for about 5 minutes to about 10 minutes. In some versions, the mixture can be strained. For instance, a 190 micron filter can be used to strain the mixture. Coating 34 can be sprayed and/or rolled onto at least a portion of a surface of packaging layer 32. Accordingly, the biodegradable additive can aid in the decomposition of packaging material 30. Still other suitable configurations for packaging material 30 will be apparent to one with ordinary skill in the art in view of the teachings herein.

### EXAMPLES

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A packaging material for transporting one or more goods, wherein the packaging material comprises one or more layers and a biodegradable additive applied to at least a portion of a surface of the one or more layers, wherein the biodegradable additive comprises an organic fertilizer having one or more nutrients such that the biodegradable additive is configured to release the one or more nutrients when the packaging material decomposes.

### Example 2

The packaging material of example 1, wherein the packaging material comprises a corrugated material having fluted layer bonded with another layer by an adhesive comprising the biodegradable additive.

### Example 3

The packaging material of example 2, wherein the fluted layer includes a plurality of peaks and a plurality of troughs to form an undulating configuration, wherein the fluted layer is positioned between a top layer and a bottom layer, wherein the adhesive is applied between the top layer and the plurality of peaks to bond the plurality of peaks with an interior surface of the top layer, wherein the adhesive is applied between the bottom layer and the plurality of troughs to bond the plurality of troughs with an interior surface of the bottom layer.

### Example 4

The packaging material of any one or more of examples 1 through 3, wherein the biodegradable additive is applied as a coating to at least a portion of the surface of the one or more layers.

### Example 5

The packaging material of any one or more of examples 1 through 4, wherein the biodegradable additive comprises a seaweed extract.

### Example 6

The packaging material of any one or more of examples 1 through 5, wherein the biodegradable additive further comprises one or more of water, starch, borax, and caustic soda to form an adhesive.

### Example 7

The packaging material of example 6, wherein the adhesive comprises from about 70% to about 78% water.

### Example 8

The packaging material of any one or more of examples 6 through 7, wherein the adhesive comprises from about 22% to about 29% starch.

### Example 9

The packaging material of any one or more of examples 6 through 8, wherein the adhesive comprises from about 0.8% to about 1% caustic soda.

### Example 10

The packaging material of any one or more of examples 6 through 9, wherein the adhesive comprises from about 0.3% to about 0.6% borax.

Example 11

The packaging material of any one or more of examples 6 through 10, wherein the adhesive comprises from about 3% to about 5% seaweed extract.

### Example 12

The packaging material of any one or more of examples 1 through 11, wherein the one or more nutrients comprises one or more of nitrogen, phosphorus, and potassium.

### Example 13

The packaging material of any one or more of examples 1 through 12, wherein the packaging material is decomposable in soil to thereby release the one or more nutrients in the soil.

### Example 14

An adhesive for bonding one or more layers of a corrugated material, wherein the adhesive comprises a biodegradable additive, wherein the biodegradable additive comprises an organic fertilizer having one or more nutrients such that the biodegradable additive is configured to release the one or more nutrients when the biodegradable additive decomposes.

### Example 15

The adhesive of example 14, wherein the adhesive comprises one or more of water, starch, borax, caustic soda, and seaweed extract.

### Example 16

The adhesive of example 15, wherein the adhesive comprises: from about 70% to about 78% water; from about 22% to about 29% starch; from about 0.8% to about 1% caustic soda; from about 0.3% to about 0.6% borax; and from about 3% to about 5% seaweed extract.

### Example 17

A method of manufacturing a biodegradable additive for application to a packaging material, the method comprising the steps of: mixing an organic fertilizer with water until the organic fertilizer is substantially dissolved; and straining the mixture to form a biodegradable additive.

### Example 18

The method of example 17, further comprising coating at least a portion of a surface of a layer of a packaging material with the biodegradable additive.

### Example 19

The method of any one or more of examples 17 through 18, further comprising mixing the strained mixture with one or more of starch, borax, and caustic soda to form an adhesive.

### Example 20

The method of example 19, further comprising applying the adhesive to a layer of a corrugated material to bond the layer with another layer of the corrugated material.

Having shown and described various embodiments of the present innovation, further adaptations of the methods and systems described herein may be accomplished by appropriate modifications by one of ordinary skill in the art without departing from the scope of the present innovation. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present innovation should be considered in terms of the following claims and is understood not to be limited to the details of structure and operation shown and described in the specification and drawings.

What is claimed is:

1. A packaging material for transporting one or more goods, wherein the packaging material comprises one or more layers and a biodegradable additive applied to at least a portion of a surface of the one or more layers, wherein the biodegradable additive comprises an organic fertilizer having one or more nutrients such that the biodegradable additive is configured to release the one or more nutrients when the packaging material decomposes.

2. The packaging material of claim 1, wherein the packaging material comprises a corrugated material having fluted layer bonded with another layer by an adhesive comprising the biodegradable additive.

3. The packaging material of claim 2, wherein the fluted layer includes a plurality of peaks and a plurality of troughs to form an undulating configuration, wherein the fluted layer is positioned between a top layer and a bottom layer, wherein the adhesive is applied between the top layer and the plurality of peaks to bond the plurality of peaks with an interior surface of the top layer, wherein the adhesive is applied between the bottom layer and the plurality of troughs to bond the plurality of troughs with an interior surface of the bottom layer.

4. The packaging material of claim 1, wherein the biodegradable additive is applied as a coating to at least a portion of the surface of the one or more layers.

5. The packaging material of claim 1, wherein the biodegradable additive comprises a seaweed extract.

6. The packaging material of claim 1, wherein the biodegradable additive further comprises one or more of water, starch, borax, and caustic soda to form an adhesive.

7. The packaging material of claim 6, wherein the adhesive comprises from about 70% to about 78% water.

8. The packaging material of claim 6, wherein the adhesive comprises from about 22% to about 29% starch.

9. The packaging material of claim 6, wherein the adhesive comprises from about 0.8% to about 1% caustic soda.

10. The packaging material of claim 6, wherein the adhesive comprises from about 0.3% to about 0.6% borax.

11. The packaging material of claim 6, wherein the adhesive comprises from about 3% to about 5% seaweed extract.

12. The packaging material of claim 1, wherein the one or more nutrients comprises one or more of nitrogen, phosphorus, and potassium.

13. The packaging material of claim 1, wherein the packaging material is decomposable in soil to thereby release the one or more nutrients in the soil.

14. An adhesive for bonding one or more layers of a corrugated material, wherein the adhesive comprises a biodegradable additive, wherein the biodegradable additive comprises an organic fertilizer having one or more nutrients such that the biodegradable additive is configured to release the one or more nutrients when the biodegradable additive decomposes.

15. The adhesive of claim 14, wherein the adhesive comprises one or more of water, starch, borax, caustic soda, and seaweed extract.

16. The adhesive of claim 15, wherein the adhesive comprises:
from about 70% to about 78% water;
from about 22% to about 29% starch;
from about 0.8% to about 1% caustic soda;
from about 0.3% to about 0.6% borax; and
from about 3% to about 5% seaweed extract.

17. A method of manufacturing a biodegradable additive for application to a packaging material, the method comprising the steps of:
mixing an organic fertilizer with water until the organic fertilizer is substantially dissolved; and
straining the mixture to form a biodegradable additive.

18. The method of claim 17, further comprising coating at least a portion of a surface of a layer of a packaging material with the biodegradable additive.

19. The method of claim 17, further comprising mixing the strained mixture with one or more of starch, borax, and caustic soda to form an adhesive.

20. The method of claim 19, further comprising applying the adhesive to a layer of a corrugated material to bond the layer with another layer of the corrugated material.
